(19) United States
(12) Patent Application Publication
(10) Pub. No.: US 2009/0012255 A1
(43) Pub. Date: Jan. 8, 2009

(54) HYDROXYL ORGANIC OLIGOSILOXANE RESIN AND PREPARATION METHOD THEREOF

(75) Inventors: Byeong-Soo Bae, Daejeon (KR); Kyung-Ho Jung, Daejeon (KR); Ji-Hoon Ko, Daejeon (KR); Jung-Ho Jin, Daejeon (KR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Korea Advanced Institute of Science and Technology, Daejeon (KR)

(21) Appl. No.: 12/166,995

(22) Filed: Jul. 2, 2008

(30) Foreign Application Priority Data
Jul. 6, 2007 (KR) 2007-0068239

(51) Int. Cl. B05D 3/06; C08G 77/08; C08G 77/14; B05D 3/02

(52) U.S. Cl. 528/14; 528/38; 528/32; 528/10; 528/21; 528/23; 427/532; 427/387

(57) ABSTRACT

Disclosed are hydroxyl organic oligosiloxane resins prepared by hydrolysis-condensation of organic alkoxysilane and preparation method thereof. More particularly, the present invention provides a method for preparation of novel resins with excellent coating properties, mechanical properties and thermal stability, comprising use of a hydroxyl organic oligosiloxane resin which has a center of inorganic network structure with high condensation degree formed by complete hydrolysis-condensation, and at least one hydroxyl group and organic group or organic functional group around the center.

### BACKGROUND OF THE INVENTION

This application claims priority to Korean Patent Application No. 2007-0068239, filed on Jul. 6, 2007, in the Korean Intellectual Property Office, the entire contents of which are hereby incorporated by reference.

### FIELD OF THE INVENTION

The present invention relates to organic oligosiloxane resins having hydroxyl groups and preparation methods thereof, more particularly, to a hydroxyl organic oligosiloxane resin useful for coating materials with excellent mechanical properties, thermal stability and coating properties, which is prepared by hydrolysis and condensation of organic alkoxysilane, and a preparation method of the same.

### DESCRIPTION OF THE RELATED ART

It is well known that organic oligosiloxane having appropriate molecular weight, which contains organic ingredients around siloxane portion having Si—O bonds, is used to produce inorganic-organic hybrid polymeric materials containing siloxane by self-polymerization of organic oligosiloxane or copolymerization of organic monomer with oligomer.

The inorganic-organic hybrid polymer is a material with potentially superior thermal-resistance and mechanical properties, which comprises a nano unit composite of organic material and inorganic material. However, such inorganic and organic materials may be phase separated due to different physical properties thereof and reduce stability of a resin.

Stable organic oligosiloxane can be prepared using alkoxysilane possible to undergo hydrolysis-condensation.

U.S. Pat. No. 6,069,259 and Chemistry of Materials, vol. 9, pp. 1554-1561, 1991 reported by J. V. Criveilo et al. disclosed a method for preparation of alkoxy organic oligosiloxane resin by hydrolysis-condensation of organic alkoxysilane. However, the alkoxy organic oligosiloxane resin does not contain hydroxyl groups which are necessarily generated by hydrolysis of alkoxy groups and has a shortcoming that the resin is difficult to use as coating material for a variety of substrates.

Organic oligosiloxane resins having multi-functional groups are obtainable by polymerization of organic silanes having chloro groups as a starting material. Techniques for preparation of inorganic-organic hybrid oligosiloxane resin from organic silanes having chloro groups are widely known and reported in the related arts.

For example, Japan Patent Laid-Open No. H8-157605 proposed copolymerization of methyltrichlorosilane or vinyl trichlorosilane and trichlorosilane to synthesize polysiloxane. But, such organic oligosilane resin according this publication has a defect such as extremely lowered stability and a restriction that it further requires post-treatment of removing hydrochloric acid necessarily generated during hydrolysis of chlorosilane.

### SUMMARY OF THE INVENTION

Accordingly, the present invention is directed to solve problems of conventional methods as described above and, an object of the present invention is to provide a method for preparation of organic oligosiloxane resin having at least one hydroxyl group with excellent coating properties, comprising: formation of siloxane structure having organic groups or organic functional groups through organic alkoxysilane applicable for hydrolysis-condensation to prepare a stable resin; and complete hydrolysis and condensation to produce the organic oligosiloxane resin with very high condensation degree and, in addition, organic oligosiloxane resin prepared by the same.

The present invention provides a hydroxyl organic oligosiloxane resin having silicon atom bonded with hydroxyl group in structure thereof, which is obtained by using organic alkoxysilane represented by the following formula as a monomer and conducting hydrolysis and condensation of two or more of the monomers as units to form an inorganic network structure of the resin:

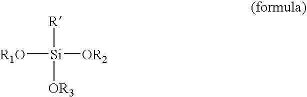

wherein R′, R₁, R₂ and R₃ are independently straight, branched or cyclic C₁-C₁₂ hydrocarbon groups having one or two or more of alkyl, ketone, acryl, methacryl, allyl, aromatic group, halogen, amino, mercapto, ether, ester, alkoxy, sulfone, nitro, hydroxy, cyclobutene, carbonyl, carboxyl, alkyd, urethane, vinyl or nitrile group, hydrogen, or epoxy functional group.

The hydroxyl organic oligosiloxane resin according to the present invention has molecular weight of less than 10,000 and, more preferably, molecular weight of 100 to 5,000 without limitation thereto. The inventive resin is useful for production of inorganic-organic oligosiloxane composite resin having at least one hydroxyl group and organic group or organic functional group by hydrolysis-condensation of alkoxysilane. Alternatively, the present inventive resin with superior mechanical properties and thermal stability is useful for production of a coating resin with excellent coating properties applicable to a variety of substrates.

The present invention further provides a method for preparation of hydroxyl organic oligosiloxane resin having silicon atom bonded with hydroxyl group in structure thereof, which comprises using organic alkoxysilane represented by the following formula as a monomer and conducting hydrolysis and condensation of two or more of the monomers as units:

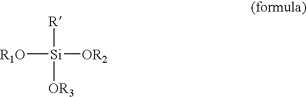

wherein R′, R₁, R₂ and R₃ are independently straight, branched or cyclic C₁-C₁₂ hydrocarbon groups having one or two or more of alkyl, ketone, acryl, methacryl, allyl, aromatic group, halogen, amino, mercapto, ether, ester, alkoxy, sulfone, nitro, hydroxy, cyclobutene, carbonyl, carboxyl, alkyd, urethane, vinyl or nitrile group, hydrogen, or epoxy functional group.

Alkoxysilane used in the preparation method according to the present invention is not particularly limited, but includes at least one selected from a group consisting of: 3-glycidoxypropyl trimethoxysilane; 3-glycidoxypropyl triethoxysilane; 2-(3,4-epoxycyclohexyl)ethyl trimethoxysilane; 2-(3,4-epoxycyclohexyl)ethyl triethoxysilane; methyltrimethoxysilane; methyltriethoxysilane; methyltripropoxysilane; propylethyltrimethoxysilane; ethyltriethoxysilane; vinyltrimethoxysilane; vinyltriethoxysilane; vinyltripropoxysilane; phenyl trimethoxysilane; N-(3-acryloxy-2-hydroxypropyl)-3-aminopropyl triethoxysilane; N-(3-acryloxy-2-hydroxypropyl)-3-aminopropyl trimethoxysilane; N-(3-acryloxy-2-hydroxypropyl)-3-aminopropyl tripropoxysilane; 3-acryloxypropylmethyl bis(trimethoxy)silane; 3-acryloxypropyl trimethoxysilane; 3-acryloxypropyl triethoxysilane; 3-acryloxypropyl tripropoxysilane; 3-(meth)acryloxypropyl trimethoxysilane, 3-(meth)acryloxypropyl triethoxysilane; 3-(meth)acryloxypropyl tripropoxysilane; N-(aminoethyl-3-aminopropyl)trimethoxysilane; N-(2-aminoethyl-3-aminopropyl)triethoxysilane; 3-aminopropyltrimethoxysilane; 3-aminopropyltriethoxysilane, chloropropyltrimethoxysilane; chloropropyltriethoxysilane; heptadecafluorodecyltrimethoxysilane; tetraethoxysilane; and tetramethoxysilane.

The preparation method of the present invention produces a hydroxyl organic alkoxysilane resin having hydroxyl group in structure thereof, which comprises hydrolysis-condensation of organic alkoxysilane compound under a constant condition to form an inorganic network structure of the resin.

The hydroxyl organic oligosiloxane resin of the present invention can be used in production of inorganic-organic hybrid polymer through thermal curing or photo-curing process. Alternatively, the inventive resin can be used in fabrication of coating films that applies the resin to any of substrates such as glass substrate, plastic substrate or metal substrate, and carries out thermal curing or photo-curing the coated resin.

The fabricated hydroxyl inorganic-organic oligosiloxane composite resin has advantages in that the resin has high condensation degree, enables a solution to have high stability and exhibits excellent thermal and mechanical properties, and superior coating properties to a variety of substrates thereby being efficiently used as coating resin.

### BRIEF DESCRIPTION OF THE DRAWINGS

These and other objects, features, aspects, and advantages of the present invention will be more fully described in the following detailed description of preferred embodiments and examples, taken in conjunction with the accompanying drawings. In the drawings:

FIG. 1 shows a result observed by Si—NMR for a hydroxyl organic oligosiloxane resin prepared according to Example 1 of the present invention;

FIG. 2 shows a result observed by MALDI-TOF for a hydroxyl organic oligosiloxane resin prepared according to Example 1 of the present invention; and

FIG. 3 shows a result observed by FT-IR for a hydroxyl organic oligosiloxane resin prepared according to Example 1 of the present invention.

### DETAILED DESCRIPTION OF THE INVENTION

Hereinafter, the present invention will be more particularly described by the preferred examples. However, these are intended to illustrate the invention as preferred embodiments of the present invention and do not limit the scope of the present invention.

### Example 1

### Preparation of Hydroxyl Amine Oligosiloxane Resin

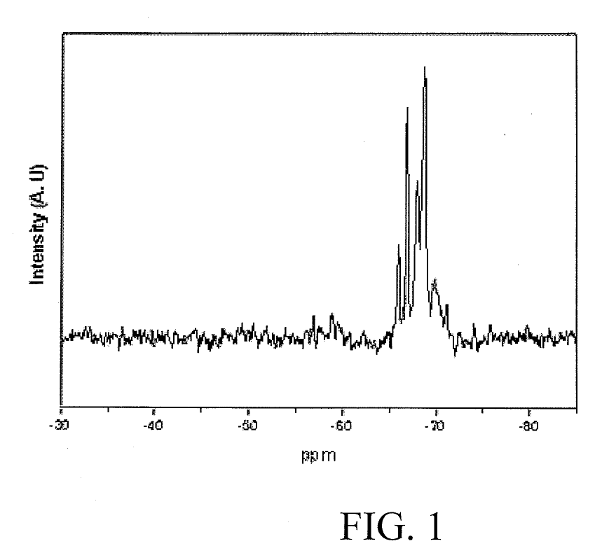

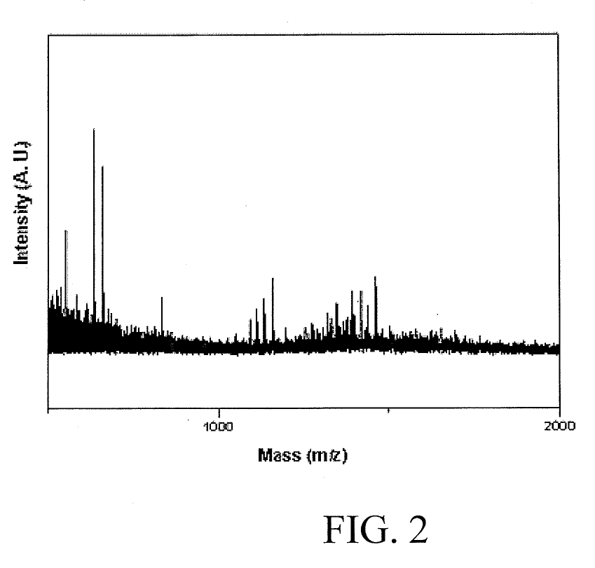

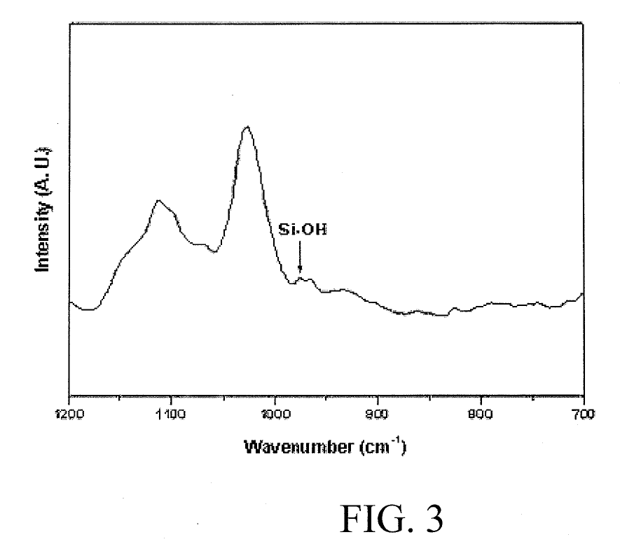

To 17.93 g of 3-aminopropyltrimethoxysilane (APTS, Aldrich), 2.7 g of distilled water was added in a molar ratio of 1:1.5 to APTS, followed by agitation of the mixture at ordinary temperature for 6 hours. After reacting the mixture with volatile materials at 60□ under 0.1 MPa for 30 minutes by using a vacuum evaporator, a hydroxyl organic oligosiloxane resin modified with amine group was produced after removing water remaining in the resin. Si—NMR for observing the produced resin, MALDI-TOF for measuring molecular weight and FT-IR for monitoring hydroxyl groups formed in the resin were implemented and results of these analyses are shown in FIGS. 1, 2 and 3, respectively. The produced resin was stably stored under nitrogen atmosphere.

### Example 2

### Preparation of Hydroxyl Methacryl Oligosiloxane Resin

To 24.84 g of 3-trimethoxylylpropylmethacrylate (MPTS, Aldrich), 5.4 g of distilled water was added in a molar ratio of 1:3 to MPTS, 0.02 g of hydrochloric acid was added to the mixture as a catalyst to accelerate reaction thereof, followed by agitation of the mixture at 80□ for 24 hours. Propyleneglycol methyletheracetate (PGMEA, Aldrich) was added to the treated mixture. After reacting the final mixture with volatile materials at 600 under 0.1 MPa for 30 minutes by using a vacuum evaporator, a hydroxyl organic oligosiloxane resin modified with methacryl group was produced after removing water remaining in the resin.

### Example 3

### Preparation of Hydroxyl Epoxy Oligosiloxane Resin

To 23.63 g of 3-glycidoxypropyltrimethoxysilane (GPTS, Aldrich), 2.7 g of distilled water was added in a molar ratio of 1:1.5 to GPTS, 0.02 g of hydrochloric acid was added to the mixture as a catalyst to accelerate reaction thereof, followed by agitation of the mixture at 80□ for 24 hours. Propyleneglycol methyletheracetate (PGMEA, Aldrich) was added to the treated mixture. After reacting the final mixture with volatile materials at 60□ under 0.1 MPa for 30 minutes by using a vacuum evaporator, a hydroxyl organic oligosiloxane resin modified with methacryl group was produced after removing water remaining in the resin.

TABLE 1

| | | Contact | Contact | Contact | 5 wt. % |
|---|---|---|---|---|---|
| | Viscos- | angle (°) | angle (°) | angle (°) | Decomposition |
| | ity | (glass | (plastic | (metal | temperature |
| | (cps) | substrate) | substrate) | substrate) | (□) |
| Example 1 | 10 to 50 | 39 | 34 | 32 | 347 |
| Example 2 | 10 to 50 | 23 | 25 | 20 | 287 |
| Example 3 | 10 to 50 | 26 | 27 | 24 | 351 |

As shown in Table 1, a hydroxyl organic oligosiloxane resin according to the present invention exhibits superior coating properties applicable to a variety of substrates. For measurement of contact angles for hydroxyl oligosiloxane resins prepared according to the examples, soda-lime glass and plastic material were adapted for a glass substrate and a substrate for printed circuit board (PCB), respectively, and stainless steel (SUS) was used as a metal substrate.

In addition, the present inventive hydroxyl organic oligosiloxane resin has potentially more excellent thermal stability than that of existing polymer and/or hybrid material since the resin is cured through polymerization of organic groups.

While the present invention has been described with reference to the preferred examples, it will be understood by those skilled in the art that various modifications and variations may be made therein without departing from the scope of the present invention as defined by the appended claims.

What is claimed is:

1. A hydroxyl organic oligosiloxane resin having silicon atom bonded with hydroxyl group in structure thereof, which is obtained by using organic alkoxysilane represented by the following formula as a monomer and conducting hydrolysis and condensation of two or more of the monomers as units to form an inorganic network structure of the resin: 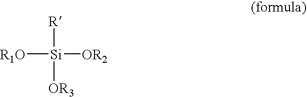
wherein R′, R₁, R₂ and R₃ are independently straight, branched or cyclic C₁-C₁₂ hydrocarbon groups having one or more of alkyl, ketone, acryl, methacryl, allyl, aromatic group, halogen, amino, mercapto, ether, ester, alkoxy, sulfone, nitro, hydroxy, cyclobutene, carbonyl, carboxyl, alkyd, urethane, vinyl or nitrile group, hydrogen, or epoxy functional group.

2. The resin according to claim 1, wherein the resin has weight average molecular weight of 100 to 10,000.

3. A method for preparation of hydroxyl organic oligosiloxane resin having silicon atom bonded with hydroxyl group in structure thereof, which comprises using organic alkoxysilane represented by the following formula as a monomer and conducting hydrolysis and condensation of two or more of the monomers as units: 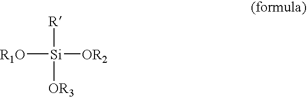
wherein R′, R₁, R₂ and R₃ are independently straight, branched or cyclic C₁-C₁₂ hydrocarbon groups having one or more of alkyl, ketone, acryl, methacryl, allyl, aromatic group, halogen, amino, mercapto, ether, ester, alkoxy, sulfone, nitro, hydroxy, cyclobutene, carbonyl, carboxyl, alkyd, urethane, vinyl or nitrile group, hydrogen, or epoxy functional group.

4. The method according to claim 3, wherein the hydrolysis and condensation are performed by using acid or base catalyst in the presence of water.

5. The method according to claim 3, wherein the organic alkoxysilane used as the monomer is at least one selected from a group consisting of: 3-glycidoxypropyl trimethoxysilane; 3-glycidoxypropyl triethoxysilane; 2-(3,4-epoxycyclohexyl)ethyl trimethoxysilane; 2-(3,4-epoxycyclohexyl)ethyl triethoxysilane; methyltrimethoxysilane; methyltriethoxysilane; methyltripropoxysilane; propylethyltrimethoxysilane; ethyltriethoxysilane; vinyltrimethoxysilane; vinyltriethoxysilane; vinyltripropoxysilane; phenyl trimethoxysilane; N-(3-acryloxy-2-hydroxypropyl)-3-aminopropyl triethoxysilane; N-(3-acryloxy-2-hydroxypropyl)-3-aminopropyl trimethoxysilane; N-(3-acryloxy-2-hydroxypropyl)-3-aminopropyl tripropoxysilane; 3-acryloxypropylmethyl bis(trimethoxy)silane; 3-acryloxypropyl trimethoxysilane; 3-acryloxypropyl triethoxysilane; 3-acryloxypropyl tripropoxysilane; 3-(meth)acryloxypropyl trimethoxysilane, 3-(meth)acryloxypropyl triethoxysilane; 3-(meth)acryloxypropyl tripropoxysilane; N-(aminoethyl-3-aminopropyl)trimethoxysilane; N-(2-aminoethyl-3-aminopropyl)triethoxysilane; 3-aminopropyltrimethoxysilane; 3-aminopropyltriethoxysilane, chloropropyltrimethoxysilane; chloropropyltriethoxysilane; heptadecafluorodecyltrimethoxysilane; tetraethoxysilane; and tetramethoxysilane.

6. The method according to claim 3, further comprising an evaporation process under atmospheric pressure or vacuum conditions as a post-treatment to remove byproduct and/or water out of the hydroxyl organic oligosiloxane resin.

7. The method ac cording to claim 3, which the hydrolysis and/or condensation are (is) performed by using at least one solvent selected from a group consisting of: aliphatic hydrocarbon solvent; ketone solvent; ether solvent; acetate solvent; alcohol solvent; amide solvent; and silicon based solvent.

8. The method according to claim 4, wherein the acidic catalyst is selected from a group consisting of: acetic acid; phosphoric acid; sulfuric acid; hydrochloric acid; nitric acid; chlorosulfonic acid; para-toluene acid; trichloroacetic acid; polyphosphoric acid; pyrophosphoric acid; hydroiodic acid; tartaric acid; and perchloric acid.

9. The method according to claim 4, wherein the basic catalyst is selected from a group consisting of: ammonia; sodium hydroxide; n-butylamine; di-n-butylamine; tri-n-butylamine; imidazole; ammonium perchlorate; potassium hydroxide; and barium hydroxide.

10. Inorganic-organic hybrid polymer prepared by thermally curing or photo-curing the hydroxyl organic oligosiloxane as defined in claim 1.

11. A process for fabrication of coating films comprising: applying the hydroxyl organic oligosiloxane as defined in claim 1 as a coating resin to a substrate, and thermally curing or photo-curing the resin.

12. The process according to claim 11, wherein the substrate is selected from glass substrate, plastic substrate and metal substrate.
